(19) United States
(12) Patent Application Publication
(10) Pub. No.: US 2025/0296375 A1
(43) Pub. Date: Sep. 25, 2025

(54) PRINTING DEVICE

(71) Applicant: SEIKO EPSON CORPORATION, Tokyo (JP)

(72) Inventors: Yutaka NAGASHIMA, MATSUMOTO-SHI (JP); Satoru MIYAMOTO, MATSUMOTO-SHI (JP); Daisuke HIRUMA, MATSUMOTO-SHI (JP)

(21) Appl. No.: 19/081,638

(22) Filed: Mar. 17, 2025

(30) Foreign Application Priority Data
Mar. 19, 2024 (JP) 2024-043237

(51) Int. Cl. B41J 29/377; B41J 11/00; B41J 13/22; B41J 29/13

(52) U.S. Cl. CPC B41J 29/377; B41J 29/13; B41J 11/0022; B41J 13/226

(57) ABSTRACT

A printing device includes an outer side duct that is fixed to a second partition and that communicates with a suction section, and an inner side duct that is fixed to the housing and that is configured to communicate with the outer side duct, wherein the inner side duct has an inner side connection opening section that is open towards the front surface side A and that is connected with the outer side duct, the outer side duct includes an outer side connection opening section configured to come into contact with and separate from the inner side connection opening section in accordance with closing and opening of the opening and closing cover, and in the inner side connection opening section, the first end section, which is closer to the upper surface, is closer to the pivot axis than is the second end section, which is farther from the upper surface.

The present application is based on, and claims priority from JP Application Serial Number 2024-043237, filed Mar. 19, 2024, the disclosure of which is hereby incorporated by reference herein in its entirety.

### BACKGROUND

### 1. Technical Field

The present disclosure relates to a printing device.

### 2. Related Art

JP-A-11-167322 discloses a configuration of an image forming apparatus in which a ventilation side duct, which is fixed to an apparatus main body, and an outer side duct, which is attached and fixed around a fulcrum, are connected to each other to form a ventilation path in the apparatus.

However, in the method described in JP-A-11-167322, there is a problem in that the outer side duct rubs against the ventilation side duct when the outer side duct is connected to and separated from the ventilation side duct, and the opening sections of the ducts are both worn down, resulting in reduction in the ability to discharge gas.

### SUMMARY

A printing device includes a head that is accommodated in the housing and that ejects a liquid onto a medium; an opening and closing cover that includes a first partition constituting a part of an upper surface of a housing and a second partition constituting a part of a front surface of the housing, and that opens and closes the housing around a pivot axis; a suction section configured to suck gas that is inside the housing; an outer side duct that is fixed to the second partition and that is in communication with the suction section; and an inner side duct that is fixed to the housing and that is configured to communicate with the outer side duct, wherein the inner side duct has an inner side connection opening section that is open towards the front surface and that is configured to connect with the outer side duct, the outer side duct includes an outer side connection opening section configured to contact with and to separate from the inner side connection opening section in accordance with closing and opening of the opening and closing cover, and in the inner side connection opening section, a first end section close to the upper surface is closer to the pivot axis than a second end section that is distant from the upper surface.

### BRIEF DESCRIPTION OF THE DRAWINGS

FIG. 1 is a schematic diagram illustrating configuration of a printing device.

FIG. 2 is a perspective view showing the external appearance of the printing device.

FIG. 3 is a perspective view showing a state where the opening and closing cover of the printing device shown in FIG. 2 is open.

FIG. 4 is a perspective view showing configuration when the opening and closing cover is closed.

FIG. 5 is a perspective view showing configuration when the opening and closing cover is open.

FIG. 6 is a perspective view showing configuration of an inner side duct and an upright duct.

FIG. 7 is a perspective view of the opening and closing cover as viewed from the front surface side.

FIG. 8 is a perspective view of the opening and closing cover as viewed from the rear surface side.

FIG. 9 is a perspective view showing a configuration of a suction section and an outer side duct.

FIG. 10 is a cross-sectional view showing configuration of the inner side duct and the upright duct.

FIG. 11 is a side view showing the opening and closing cover being opened and closed.

### DESCRIPTION OF EMBODIMENTS

Hereinafter, a configuration of a printing device 1 will be described with reference to the drawings. In each of the following drawings, three axes orthogonal to each other are described as an X-axis, a Y-axis, and a Z-axis. It is assumed that a direction along the X-axis is an “X direction”, a direction along the Y-axis is a “Y direction”, a direction along the Z-axis is a “Z direction”, a direction of an arrow is a +direction, and a direction opposite to the +direction is a −direction. A view from the +Z direction or the −Z direction is also referred to as a plan view or planar.

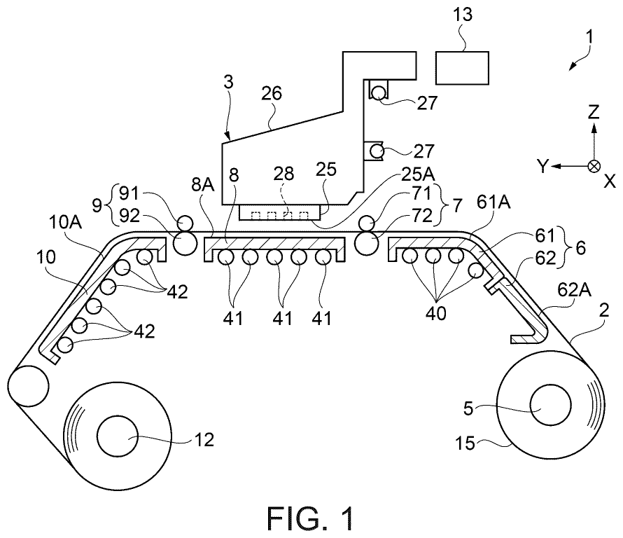

First, configuration of the printing device 1 will be described with reference to FIG. 1.

As shown in FIG. 1, the printing device 1 includes a printing section 3 and a control unit 13. The printing section 3 performs printing by depositing ink on a medium 2. The control unit 13 is a controller that controls the printing device 1. The printing device 1 is an inkjet type printer that prints an image, such as a character or a photograph, on a medium 2 by ejecting ink, which is an example of a liquid, onto the medium 2, such as a transported sheet. The printing section 3 is a serial type that performs printing while reciprocating in the width direction of the medium 2. The printing section 3 may be configured as a line type provided spanning the width direction of the medium 2.

The printing device 1 includes the printing section 3, a feed shaft 5, an upstream support section 6, an upstream transport section 7, a platen 8, a downstream transport section 9, a downstream support section 10, a winding shaft 12, and the control unit 13. The upstream support section 6, the upstream transport section 7, the platen 8, the downstream transport section 9, and the downstream support section 10 are located on a transport path along which the medium 2 is transported.

The feed shaft 5 is a rod-shaped member extending along the X-axis. The feed shaft 5 is supported by a frame or the like (not shown) at both end portions in the #X direction. The feed shaft 5 rotatably supports a roll 15 formed by winding the elongated medium 2 over itself into a cylindrical shape. The feed shaft 5 feeds the medium 2 from the roll 15 toward the upstream support section 6 by rotating.

The upstream support section 6, the platen 8, and the downstream support section 10 are members that support the elongated medium 2 being transported in the transport direction. The medium 2 is transported along the surfaces of the upstream support section 6, the platen 8, and the downstream support section 10. A direction along the surfaces of the upstream support section 6, the platen 8, and the downstream support section 10 is the transport direction of the medium 2. The transport direction intersects the X-axis. The upstream support section 6, the platen 8, and the downstream support section 10 are fixed to a frame or the like (not shown) that supports the entire printing device 1.

The upstream support section 6 includes an upstream heating support section 61, an upstream guide support section 62, and upstream heating sections 40. The upstream support section 6 supports the portion of the medium 2 that is on the upstream side in the transport direction from the portion facing the printing section 3. The platen 8 is located downstream in the transport direction from the upstream support section 6. The medium 2 supported by the upstream support section 6 is transported to the platen 8 by the upstream transport section 7. The upstream transport section 7 is located downstream in the transport direction from the upstream support section 6. The upstream transport section 7 is located upstream in the transport direction from the platen 8.

The upstream transport section 7 includes a first roller 71 and a second roller 72. The first roller 71 and the second roller 72 each extend along the X-axis. The upstream transport section 7 includes a motor (not shown). The power from the motor is transmitted to the second roller 72. The second roller 72 can be rotated by power from the motor. The medium 2 is sandwiched between the first roller 71 and the second roller 72. The medium 2 can be transported by rotating the second roller 72 in a state where the medium 2 is sandwiched between the first roller 71 and the second roller 72. The upstream transport section 7 transports the medium 2 toward the platen 8.

In the printing device 1, the second roller 72 is a driving roller, and the first roller 71 is a driven roller. The driving roller is rotationally driven by power from a motor. The driven roller follows the rotational drive of the driving roller. However, either the first roller 71 or the second roller 72 may be a driving roller or a driven roller. Note that sandwiching the medium 2 between the first roller 71 and the second roller 72 is also referred to as nipping. In the printing device 1, nipping of the medium 2 by the first roller 71 and the second roller 72 can be released by separating the first roller 71 from the second roller 72.

In the printing device 1, nipping can be released by raising the first roller 71 with respect to the second roller 72. The state can be changed to the nipping state by lowering the first roller 71 from the state in which nipping is released. The nipping state and the nipping release state are not related to the presence or absence of the medium 2. That is, regardless of the presence or absence of the medium 2, a state where first roller 71 is raised with respect to second roller 72 is the nipping release state. Similarly, regardless of the presence or absence of the medium 2, a state in which the first roller 71 is lowered from the nipping release state is the nipping state. For example, when a new roll 15 is set on the feed shaft 5, nipping is released to pass the leading end of medium 2 fed from roll 15 between first roller 71 and second roller 72.

The platen 8 is positioned in the −Z direction of the printing section 3. The platen 8 faces the printing section 3 with the transport path interposed therebetween. The platen 8 supports the portion of the medium 2 that is printed on by the printing section 3. The support surface 8A, which is the surface of the platen 8 that faces in the +Z direction, is the surface that supports the medium 2. The support surface 8A is substantially horizontal. The platen 8 can apply an attraction force to the medium 2. The surface of the platen 8 that faces the printing section 3 is flat. The support surface 8A of the platen 8 extends across a range in which printing can be performed by the printing section 3. The medium 2 may be attracted to the support surface 8A of the platen 8 by using a suction fan to suck air through a plurality of suction holes formed in the support surface 8A of the platen 8.

The printing section 3 includes a head 25, a carriage 26, and a guide shaft 27. A plurality of nozzles 28 for ejecting ink are formed in the head 25. The plurality of nozzles 28 are opened in the nozzle surface 25A of the head 25. The guide shaft 27 is a rod-shaped member extending along the X-axis. The guide shaft 27 is supported by a frame or the like (not shown) at both ends in the +X directions. The guide shaft 27 guides movement of the carriage 26.

The carriage 26 holds the head 25 and, by drive of a driving mechanism (not shown), reciprocates the head 25 in the #X direction along the guide shaft 27. The head 25 performs printing on the medium 2 by ejecting ink toward the medium 2 while moving. In the printing device 1, printing is performed by ejecting ink from the head 25 toward the region of the medium 2 that overlaps the platen 8.

The medium 2 supported by the platen 8 is transported to the downstream support section 10 by the downstream transport section 9. The medium 2 is transported in the +Y direction while being supported by the support surface 8A of the platen 8. The downstream transport section 9 is located downstream of the platen 8 in the transport direction. The downstream transport section 9 is positioned upstream of the downstream support section 10 in the transport direction.

The downstream transport section 9 includes a third roller 91 and a fourth roller 92. The third roller 91 and the fourth roller 92 each extend along the X-axis. The downstream transport section 9 includes a motor (not shown). The power from the motor is transmitted to the fourth roller 92. The fourth roller 92 can be rotated by the power from the motor. The medium 2 is nipped between the third roller 91 and the fourth roller 92. The downstream transport section 9 can transport the medium 2 by rotating the fourth roller 92 in a state where the medium 2 is nipped between the third roller 91 and the fourth roller 92. The downstream transport section 9 transports the medium 2 toward the downstream support section 10.

The downstream support section 10 is located downstream of the platen 8 in the transport direction. The downstream support section 10 supports the portion of the medium 2 that is further downstream in the transport direction than the portion that faces the printing section 3.

The winding shaft 12 is located downstream of printing section 3 in the transport direction. The winding shaft 12 winds up the medium 2 that is being transported. The winding shaft 12 is located downstream of the downstream support section 10 in the transport direction. The medium 2 is transported along the downstream support section 10 and then wound up by the winding shaft 12.

The printing device 1 includes the upstream heating sections 40, print heating sections 41, and downstream heating sections 42. The upstream heating sections 40 are provided in the upstream support section 6. The upstream heating sections 40 heat the medium 2 supported by the first support surface 61A via the upstream support section 6. The print heating sections 41 are provided to the platen 8. The print heating sections 41 heat the medium 2 supported on the support surface 8A via the platen 8. The downstream heating sections 42 are provided to the downstream support section 10. The downstream heating sections 42 heat the medium 2 supported by the downstream support surface 10A via the downstream support section 10.

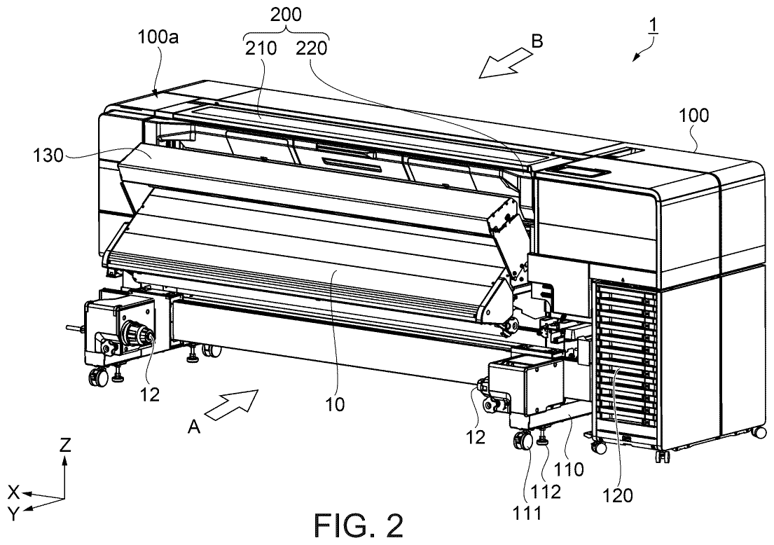

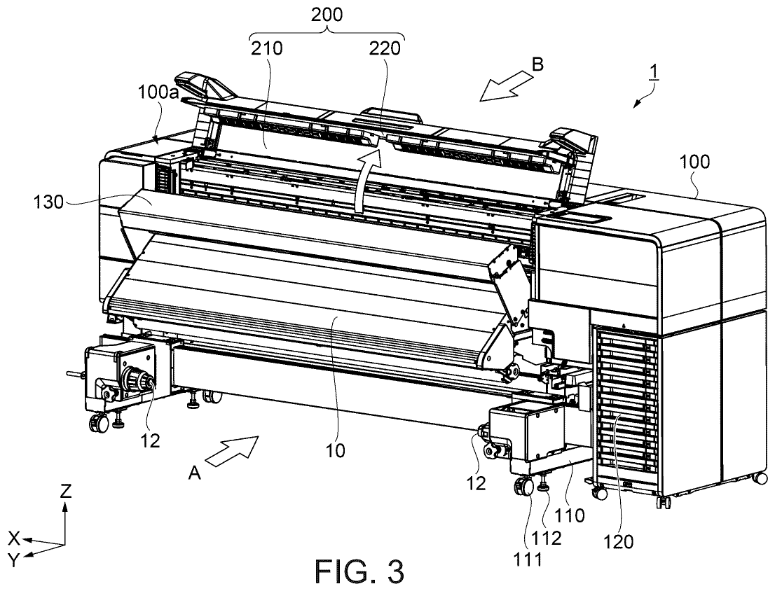

Next, configuration of the printing device 1 will be described with reference to FIGS. 2 and 3.

As shown in FIGS. 2 and 3, the printing device 1 includes a housing 100. Leg frames 110 are attached to portions near both X-direction ends of the housing 100. Casters 111 and adjusters 112 are provided below the leg frame 110. By using the casters 111, the printing device 1 can be easily moved. By using the adjusters 112, it is possible to adjust height at plural locations and to suitably install the printing device 1 on the installation surface.

As described above, the housing 100 includes the printing section 3, the upstream transport section 7, the platen 8, the downstream transport section 9, and the control unit 13. As described above, the printing device 1 includes the feed shaft 5, the upstream support section 6, the downstream support section 10, and the winding shaft 12 (refer to FIG. 1).

The printing device 1 includes the head 25 (refer to FIG. 1) that ejects ink. The head 25 is accommodated in the housing 100. The printing device 1 includes a liquid supply section 120 that supplies ink to the head 25. The liquid supply section 120 and the head 25 are configured so that ink can be supplied via a liquid supply path (not shown).

The printing device 1 performs printing by ejecting ink onto the medium 2 that is being transported, while reciprocating the head 25 in the X direction. A fan section 130 that blows a gas flow onto the medium 2 is provided to the portion of the printing device 1 that faces the downstream support section 10. The ink ejected onto the medium 2 can be dried by blowing the gas flow onto the medium 2.

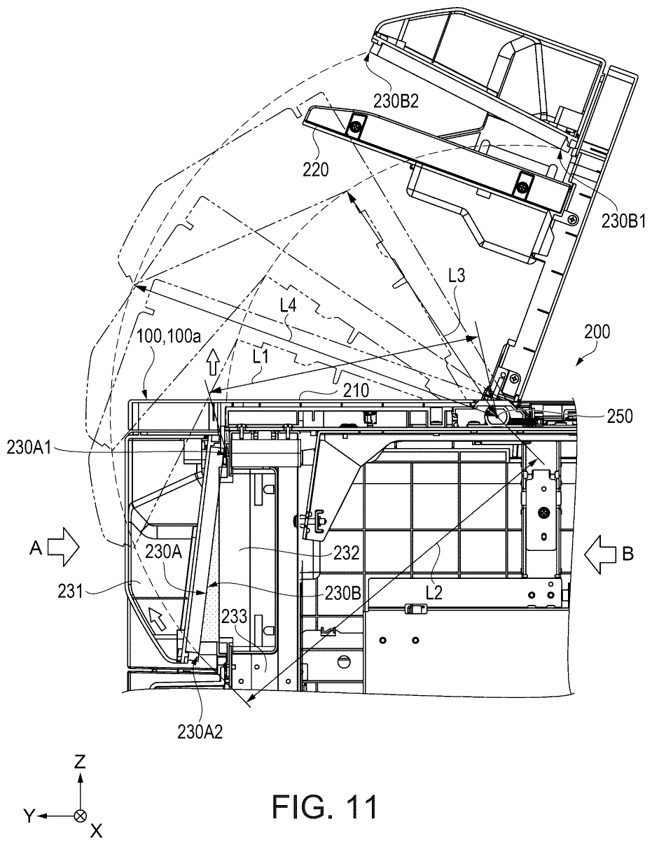

An opening and closing cover 200 is provided on the front surface side A of the housing 100. The opening and closing cover 200 includes a first partition 210 constituting a part of the upper surface 100a of the housing 100 and a second partition 220 constituting a part of the front surface side A of the housing 100. Note that the front surface side A refers to a state in which the printing device 1 is viewed in the −Y direction from the +Y direction. The rear surface side B refers to a state in which the printing device 1 is viewed in the +Y direction from the −Y direction. The opening and closing cover 200 opens and closes (refer to FIG. 2) a portion of the housing 100 centered on a pivot axis 250 (refer to FIG. 11).

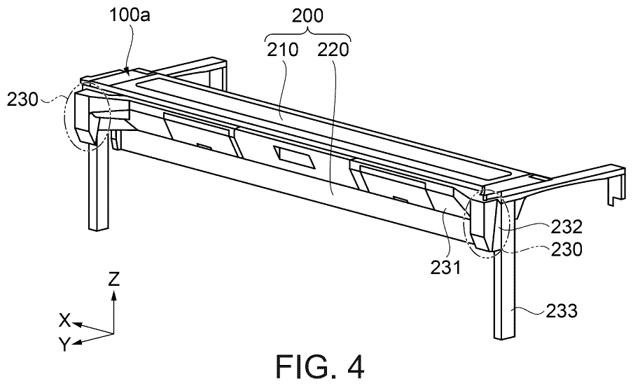

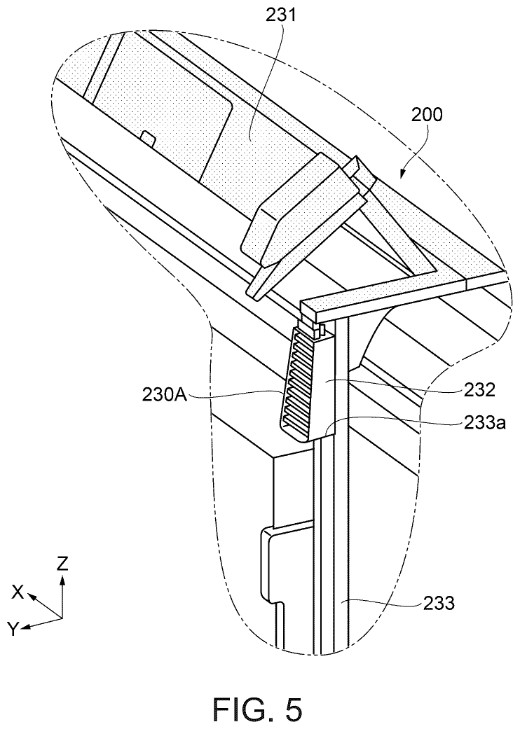

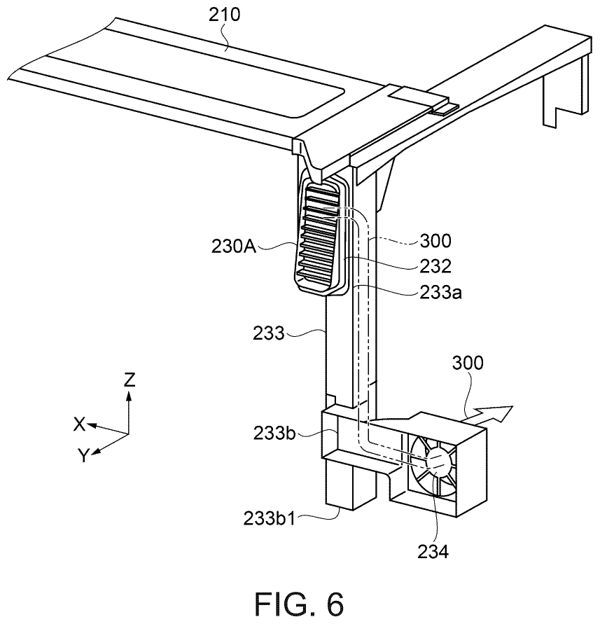

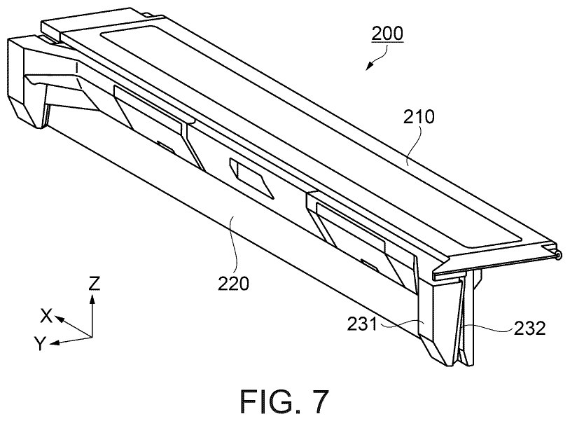

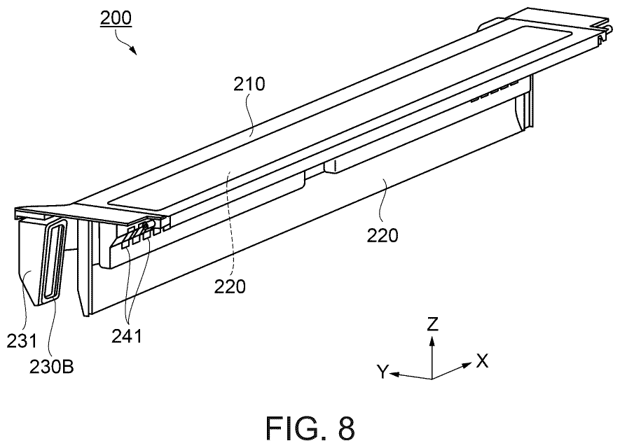

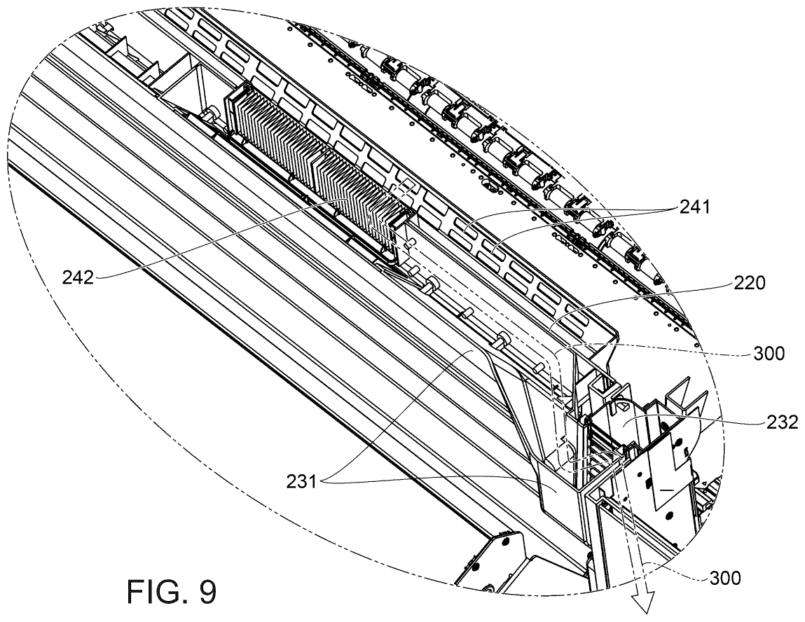

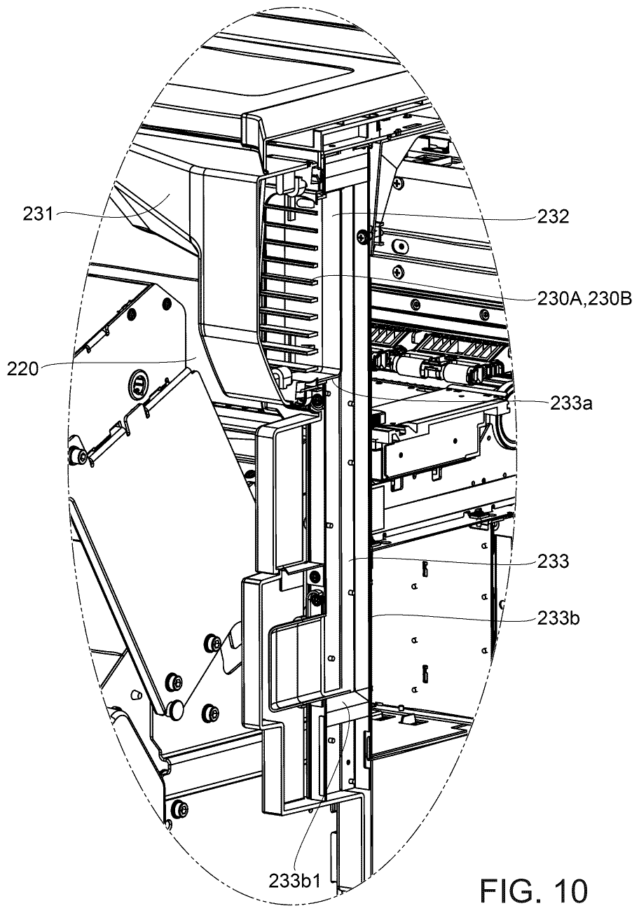

Next, a configuration around the opening and closing cover 200 will be described with reference to FIGS. 4 to 10. Note that FIG. 4 illustrates configuration at the time when the opening and closing cover 200 of the housing 100 is closed. FIG. 5 shows configuration of the opening and closing cover 200 and an inner side duct 232 at the time when the opening and closing cover 200 is open. FIG. 6 shows configuration of the inner side duct 232, which includes an upright duct 233. FIG. 7 shows configuration in which the front surface side of the opening and closing cover 200 is visible. FIG. 8 shows configuration in which the inner side duct 232 side of the opening and closing cover 200, that is, the rear surface side, is visible. FIG. 9 shows configuration when the first partition 210 of the opening and closing cover 200 is removed. FIG. 10 shows cross-sectional configuration of the inner side duct 232 and the upright duct 233.

As shown in FIG. 4, as described above, the opening and closing cover 200 includes the first partition 210 constituting a part of the upper surface 100a of the housing 100 and the second partition 220 constituting a part of the front surface side A (refer to FIG. 3) of the housing 100. In a state where the opening and closing cover 200 is closed, the transport path is positioned in the −Z direction of the second partition 220, and a gap is provided that is necessary for discharging the medium 2 from the housing 100. The second partition 220 may be formed of a transparent material.

The outer side duct 231 is fixed to the outer side of the second partition 220, that is, to the +Y direction side (refer to FIG. 9). As shown in FIG. 5, the inner side duct 232, which communicates with the outer side duct 231, is fixed to the housing 100. Connecting sections 230 that connect the outer side duct 231 and the inner side duct 232 are provided at both X direction end portions of the second partition 220 (refer to FIG. 4).

As shown in FIG. 9, the second partition 220 of the opening and closing cover 200 is provided with a suction section 241 for sucking gas 300 into the housing 100. The suction section 241 is provided on the inner side of the second partition 220, that is, on the −Y direction side. The second partition 220 is interposed between the suction section 241 and the outer side duct 231. The gas 300 includes liquid droplets that remain in the housing 100 when ink is ejected from the nozzles 28 onto the medium 2. The suction section 241 and the outer side duct 231 are in communication with each other via a filter 242.

Specifically, the gas 300 sucked from the suction section 241 passes through the filter 242, which catches the liquid droplets contained in the gas 300. The gas 300 that passed through the filter 242 passes through the outer side duct 231 and enters the inner side duct 232 via the connecting section 230. The gas 300 that entered the inner side duct 232 passes through the inner side duct 232, specifically, the upright duct 233 (refer to FIG. 6), and is discharged out from the housing 100 via a gas flow generating section 234, such as an exhaust fan.

As shown in FIG. 5, the inner side duct 232 has an inner side connection opening section 230A that opens toward the front surface side A and that is configured to connect with the outer side duct 231. In particular, the inner side connection opening section 230A is inclined towards the front surface side A and upwards, that is, toward the +Z direction. In other words, the inner side connection opening section 230A is inclined obliquely upward. As shown in FIG. 8, the outer side duct 231 has an outer side connection opening section 230B configured to be able to come into contact with and separate from the inner side connection opening section 230A in accordance with the opening and closing of the opening and closing cover 200.

As shown in FIG. 6, the inner side duct 232 includes the upright duct 233. The upright duct 233 is in communication with the gas flow generating section 234. That is, the upright duct 233 is disposed closer to the gas flow generating section 234 than is the inner side connection opening section 230A. In other words, the upright duct 233 is disposed at some point along the flow path that connects the inner side connection opening section 230A and the gas flow generating section 234.

The upright duct 233 is formed of, for example, a hollow angular member. The upright duct 233 also functions as a frame constituting the housing 100.

As described above, since the upright duct 233 is provided, the gas 300 that passed through the opening and closing cover 200 from the suction section 241 can be discharged to the lower outside of the housing 100 via the upright duct 233. Therefore, gas 300 containing liquid droplets remaining inside the housing 100 can be removed.

Since the upright duct 233 is formed of a hollow angular member, it can be used as a frame of the housing 100 and can discharge the gas 300 to the lower side of the housing 100. Further, since the upright duct 233 functions as a frame, the amount of material used can be minimized, and costs can be reduced.

As shown in FIGS. 5 and 6, the upright duct 233 formed of the angular member has an upper opening 233a which is open across plural surfaces and a lower opening 233b that is formed below the upper opening 233a and that is open across plural surfaces. Specifically, the upper opening 233a is opened, for example, across two side surfaces of the angular member that extends along the Z direction. The lower opening 233b is opened, for example, across two side surfaces of the angular member, which extends along the Z direction. By providing the opening across plural surfaces, the area of the opening can be larger than that in the case where the opening is provided in a single surface.

The upper opening 233a allows the gas 300 flowing from the inner side connection opening section 230A to flow in. The gas 300 flows out the lower opening 233b toward the gas flow generating section 234. The lower opening 233b is formed above the lower end 233b1 of the angular member.

As described above, since the angular member with the upper opening 233a and the lower opening 233b is used, the gas 300 inside the housing 100 can be discharged toward the gas flow generating section 234 while changing the flow direction. The lower opening 233b is formed above the lower end 233b1. In other words, the upright duct 233 extends below the lower opening 233b. Therefore, a light substance such as gas 300 will change its direction from the lower opening 233b provided somewhere along the upright duct 233 to the direction of the gas flow generating section 234 and flows out, but a heavy solid substance or the like will fall within the upright duct 233 to a position lower than the lower opening 233b due to gravity. In the present embodiment, since the inner side connection opening section 230A is inclined obliquely upward, there is a possibility that a foreign substance will enter from the inner side connection opening section 230A. However, when a foreign substance passes through the upright duct 233, it will fall below the lower opening 233b and will not flow out toward the gas flow generating section 234. That is, foreign matter can be caught below the lower opening 233b in the upright duct 233. As a result, it is possible to mitigate contact of intrusive foreign matter with the gas flow generating section 234, and to reduce the occurrence of failure.

Next, the opening and closing operation of the opening and closing cover 200 will be described with reference to FIG. 11.

As shown in FIG. 11 and as described above, the opening and closing cover 200 is provided on the upper portion of the front surface side A of the housing 100. The opening and closing cover 200 includes the first partition 210 and the second partition 220. The section where the opening and closing cover 200 and the housing 100 come together, that is, the inner side connection opening section 230A of the inner side duct 232, is inclined to face the front surface side A and the upper side. In other words, the inner side connection opening section 230A has an inclined surface which points obliquely upwards.

In the closed state (refer to FIGS. 2 and 11), the opening and closing cover 200 is closed in a state where the outer side connection opening section 230B of the outer side duct 231 and the inner side connection opening section 230A of the inner side duct 232 come together. The opening and closing cover 200 pivots about the pivot axis 250 to open and close a portion of the housing 100.

With respect to the inner side connection opening section 230A of the connecting sections 230 provided in the housing 100, its first end section 230A1, which is closer to the upper surface 100a, is nearer to the pivot axis 250 than is its second end section 230A2, which is further from the upper surface 100a. To be specific, a distance L1 between the pivot axis 250 and the first end section 230A1 is shorter than a distance L2 between the pivot axis 250 and the second end section 230A2.

With respect to the outer side connection opening section 230B of the connecting sections 230 of the opening and closing cover 200, its first end section 230B1, which is closer to the upper surface 100a, is positioned nearer to the pivot axis 250 than its second end section 230B2, which is further from the upper surface 100a. To be specific, a distance L3 between the pivot axis 250 and the first end section 230B1 is shorter than a distance L4 between the pivot axis 250 and the second end section 230B2.

As described above, since the inner side connection opening section 230A is inclined to face the front surface side A and upward, in other words, since the second end sections 230A2 and 230B2 are separated away from the pivot axis 250, when the opening and closing cover 200 is opened and closed, the upper end portion of the opening and closing cover 200, that is, the first end section 230B1 is pivotally moved (refer to the arrow) around the pivot axis 250 so as to draw a small circle. On the other hand, the lower end of the opening and closing cover 200, that is, the second end section 230B2, is pivotally moved (refer to the arrow) about the pivot axis 250 so as to draw a large circle. The first end section 230B1 has a smaller rotation radius around the pivot axis 250 than does the second end section 230B2.

Therefore, when the outer side duct 231 and the inner side duct 232 come into contact with or separate from each other, since the rotation radius of the second end section 230B2 of the outer side connection opening section 230B is larger than that of the first end section 230B1 of the outer side connection opening section 230B, the paths of the rotational movement of the first end section 230B1 and the second end section 230B2 are different. Therefore, rubbing between the outer side duct 231 and the inner side duct 232 can be suppressed, and wear of the outer side duct 231 and the inner side duct 232 can be suppressed. When the outer side duct 231 and the inner side duct 232 are separated from each other, the opening and closing cover 200 is rotated from the side of the end portion having a large rotation radius toward the side of the end portion having a small rotation radius.

As described above, the printing device 1 of the present embodiment includes the head 25 that is accommodated in the housing 100 and that ejects liquid onto the medium 2, the opening and closing cover 200 that includes the first partition 210 constituting a part of the upper surface 100a of the housing 100 and the second partition 220 constituting a part of the front surface of the housing 100, and that opens and closes the housing 100 around the pivot axis 250, the suction section 241 configured to suck gas 300 that is inside the housing 100, the outer side duct 231 that is fixed to the second partition 220 and that is in communication with the suction section 241, and the inner side duct 232 that is fixed to the housing 100 and that is configured to communicate with the outer side duct 231, wherein the inner side duct 232 has an inner side connection opening section 230A that is open towards the front surface and that is connected with the outer side duct 231, the outer side duct 231 includes an outer side connection opening section 230B configured to come into contact with and separate from the inner side connection opening section 230A in accordance with closing and opening of the opening and closing cover 200, and in the inner side connection opening section 230A, the first end section 230A1, which is closer to the upper surface 100a, is closer to the pivot axis 250 than is the second end section 230A2, which is farther from the upper surface 100a.

According to this configuration, since the first end section 230A1 is closer to the pivot axis 250 than is the second end section 230A2, in other words, since the second end section 230A2 is farther from the pivot axis 250, when the opening and closing cover 200 is opened and closed, the second end section 230B2 of the outer side connection opening section 230B of the opening and closing cover 200 rotates so as to draw a large circle. Therefore, it is possible to suppress rubbing between the outer side duct 231 and the inner side duct 232, and to suppress wear of the outer side duct 231 and the inner side duct 232, when the outer side duct 231 and the inner side duct 232 come into contact with or separate from each other. Accordingly, the sealing property between the outer side duct 231 and the inner side duct 232 is maintained, and performance of exhausting the gas 300 can be improved.

In the printing device 1 of the present embodiment, it is desirable that the inner side connection opening section 230A be inclined so as to face the front surface and upward. According to this configuration, since the inner side connection opening section 230A is inclined to face the front surface and the upper side, when the opening and closing cover 200 is opened and closed, the lower end of the opening and closing cover 200, that is, the second end section 230B2, rotates so as to draw a large circle. Therefore, when the outer side duct 231 and the inner side duct 232 come into contact with or separate from each other, rubbing between the outer side duct 231 and the inner side duct 232 can be suppressed.

It is desirable that the printing device 1 of the embodiment includes the gas flow generating section 234, which is in communication with the inner side duct 232 and which generates a gas flow, and that the inner side duct 232 includes the upright duct 233, which is further toward the gas flow generating section 234 side than is the inner side connection opening section 230A. According to this configuration, since the upright duct 233 is provided, the gas 300 that passed through the outer side duct 231 of the opening and closing cover 200 from the suction section 241 can be discharged to the lower outside of the housing 100 via the inner side duct 232 and the upright duct 233. Therefore, it is possible to remove gas 300 that contains the liquid droplets lingering around the head 25.

In the printing device 1 of the embodiment, it is desirable that the upright duct 233 is a frame constituting the housing 100. According to this configuration, since the upright duct 233 is provided in the frame, the material to be used can be minimized, and costs can be reduced.

In printing device 1 of the present embodiment, the upright duct 233 is desirably formed of a hollow angular member. According to this configuration, since the upright duct 233 is formed of a hollow angular member, it can be used as a frame of the housing 100 and also the gas 300 can be discharged to the lower side of the housing 100.

In the printing device 1 of the embodiment, it is desirable that the angular member has the upper opening 233a, which is open across plural surfaces, and the lower opening 233b, which is formed below the upper opening 233a and which is open across plural surfaces, that the gas 300 flowing from the inner side connection opening section 230A enters the upper opening 233a, and that the gas 300 flows out from the lower opening 233b toward the gas flow generating section 234. According to this configuration, since the angular member having the upper opening 233a and the lower opening 233b is used, the gas 300 sucked from the suction section 241 can be discharged in the direction of the gas flow generating section 234.

In the printing device 1 of the present embodiment, the lower opening 233b is desirably formed above the lower end 233b1 of the angular member. According to this configuration, the lower opening 233b is formed above the lower end 233b1. In other words, the upright duct 233 extends below the lower opening 233b. Therefore, foreign matter can be caught below the lower opening 233b in the upright duct 233.

What is claimed is:

1. A printing device comprising;
a head that is accommodated in the housing and that ejects a liquid onto a medium;
an opening and closing cover that includes a first partition constituting a part of an upper surface of a housing and a second partition constituting a part of a front surface of the housing, and that opens and closes the housing around a pivot axis;
a suction section configured to suck gas that is inside the housing;
an outer side duct that is fixed to the second partition and that is in communication with the suction section; and
an inner side duct that is fixed to the housing and that is configured to communicate with the outer side duct, wherein
the inner side duct has an inner side connection opening section that is open towards the front surface and that is configured to connect with the outer side duct,
the outer side duct includes an outer side connection opening section configured to contact with and to separate from the inner side connection opening section in accordance with closing and opening of the opening and closing cover, and
in the inner side connection opening section, a first end section close to the upper surface is closer to the pivot axis than a second end section that is distant from the upper surface.

2. The printing device according to claim 1, wherein
the inner side connection opening section is inclined so as to face the front surface and upward.

3. The printing device according to claim 1, further comprising;
a gas flow generating section that is in communication with the inner side duct and that generates a gas flow, wherein
the inner side duct includes an upright duct on a side that is closer to the gas flow generating section than is the inner side connection opening section.

4. The printing device according to claim 3, wherein
the upright duct is a frame constituting the housing.

5. The printing device according to claim 3, wherein
the upright duct is formed of a hollow angular member.

6. The printing device according to claim 5, wherein
the angular member has an upper opening that is open across plural surfaces and a lower opening that is formed below the upper opening and that is open across plural surfaces,
the upper opening is configured so that gas flowing from the inner side connection opening section flows into the upper opening, and
the lower opening is configured so that gas flows out toward the gas flow generating section.

7. The printing device according to claim 6, wherein
the lower opening is formed above the lower end of the angular member.
